(19) United States
(12) Patent Application Publication
(10) Pub. No.: US 2011/0316703 A1
(43) Pub. Date: Dec. 29, 2011

(54) System and Method for Ensuring Sanitation Procedures in Restrooms

(76) Inventors: Andy Butler, Palo Alto, CA (US); Todd Pope, Napa, CA (US); Jeffrey B. Godfrey, Fairfield, CA (US)

(21) Appl. No.: 13/098,181

(22) Filed: Apr. 29, 2011

Related U.S. Application Data
(60) Provisional application No. 61/329,433, filed on Apr. 29, 2010.
(60) Provisional application No. 61/371,601, filed on Aug. 6, 2010.

(51) Int. Cl. G08B 23/00

(52) U.S. Cl. 340/573.1

(57) ABSTRACT

A system and method for automatically monitoring hand sanitation practices in a lavatory. The embodiments involve identifying a user, determining a proper hand sanitation protocol for the user, and monitoring the user to ensure the user satisfies the protocol. If the user does not satisfy the protocol the user may be subject to various alarms. The results of the monitoring can be stored for later analysis.

### RELATED APPLICATIONS

This application is related to and claims priority from U.S. Provisional application 61/329,433 filed on Apr. 29, 2010 and U.S. Provisional application No. 61/371,601 filed on Aug. 6, 2010 which are incorporated by reference herein in their entirety. which is incorporated by reference herein in its entirety.

### FIELD OF THE INVENTION

The invention relates to the field of water filters and more particularly the monitoring and enforcement of sanitation protocols.

### BACKGROUND

Hand sanitation after restroom use is important to individual and public health, and to the prevention of the spread of disease. For restaurant, food service, and commercial food workers, who are in direct contact with food and beverages, hand sanitation is a mandatory requirement and serious issue impacting public health. This issue also applies to health care workers, and workers in other fields. To a large extent, restaurants, food service, commercial food establishments and other businesses rely solely upon employee training, signage on restroom walls, and written policies and procedures to ensure proper hand sanitation practices are followed. It is currently impractical to monitor or test workers for compliance with hand sanitation polices after each toilet and/or restroom use. Thus, to a large extent, the practice of hand sanitation relies almost entirely on self-discipline and self policing. What is needed is a system and method to monitor hand sanitation practices.

### SUMMARY

A system and method for automatically monitoring hand sanitation practices in a lavatory. The embodiments involve identifying a user, determining a proper hand sanitation protocol for the user, and monitoring the user to ensure the user satisfies the protocol. If the user does not satisfy the protocol the user may be subject to various alarms. The results of the monitoring can be stored for later analysis.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 is an illustration of an environment in which one embodiment may operate.

FIG. 2 is a more detailed illustration of a restroom monitor in accordance with an embodiment.

FIG. 3 is a more detailed illustration of a remote server in accordance with an embodiment.

FIG. 4 is a flowchart of the operation of various embodiments.

FIG. 5 is a more detailed flowchart of the identifying step of FIG. 4 in accordance with an embodiment.

FIGS. 6a-b are a more detailed flowchart of the monitoring step of FIG. 4 in accordance with an embodiment.

FIG. 7 is a more detailed flowchart of the storing step of FIG. 4 in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

A preferred embodiment of the present invention is now described. Reference in the specification to “one embodiment” or to “an embodiment” means that a particular feature, structure, or characteristic described in connection with the embodiments is included in at least one embodiment of the invention. The appearances of the phrase “in one embodiment” or “an embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations or transformation of physical quantities or representations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by a variety of operating systems. The invention can also be in a computer program product which can be executed on a computing system.

The present invention also relates to an apparatus for performing the operations herein. This apparatus may be specially constructed for the purposes, e.g., a specific computer, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

In addition, the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

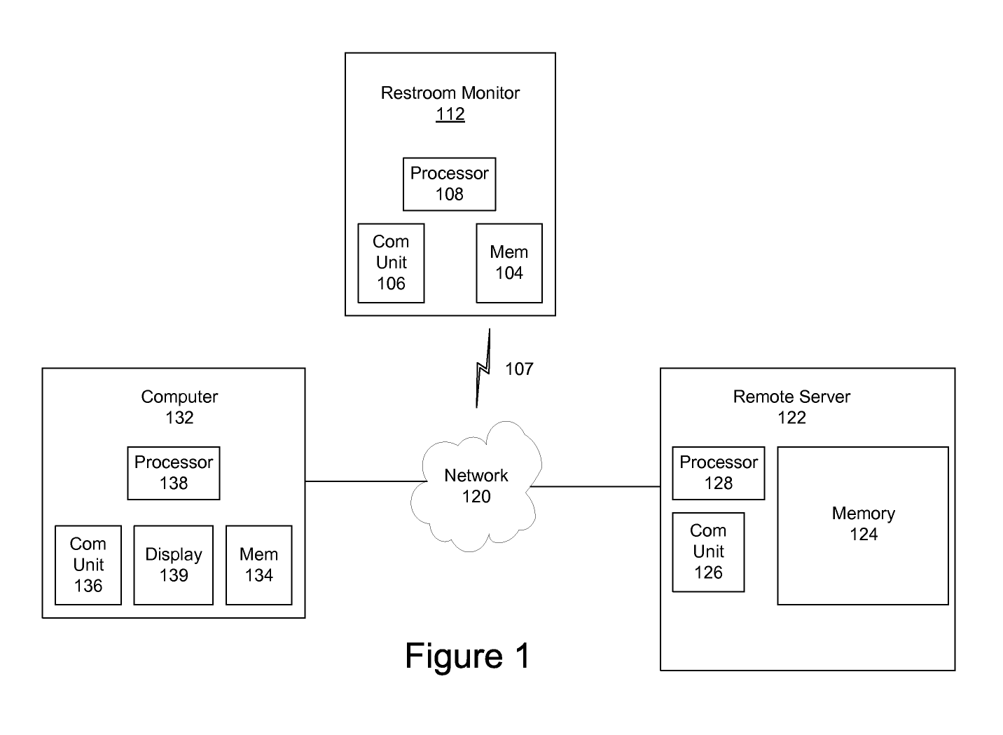

FIG. 1 is an illustration of an environment in which one embodiment may operate. The operating environment may include a restroom monitor 112 which can include a processor 108, a memory device 104 and a communications unit 106. A communication link 107 for communications between the restroom monitor 112 and a network 120. The communication links described herein can directly or indirectly connect these devices. The network 120 can be, for example, a wireline or wireless communication network such as a WiFi, other wireless local area network (WLAN), a cellular network comprised of multiple base stations, controllers, and a core network that typically includes multiple switching entities and gateways. Other examples of the network 120 include the Internet, a public-switched telephone network (PSTN), a packet-switching network, a frame-relay network, a fiber-optic network, combinations thereof, and/or other types/combinations of networks.

Processors 108, 128 and/or 138 process data signals and may comprise various computing architectures including a complex instruction set computer (CISC) architecture, a reduced instruction set computer (RISC) architecture, or an architecture implementing a combination of instruction sets. Although only a single processor is shown in FIG. 1, multiple processors may be included. The processors can comprise an arithmetic logic unit, a microprocessor, a microcontroller, a general purpose computer, or some other information appliance equipped to transmit, receive and process electronic data signals from the memory 104, 124, 134 and other devices both shown and not shown in the figures.

The remote server 122 includes a processor 128, examples of which are described above, and a communication unit 126 for communicating with the Network 120, for example. The remote server 122 also includes a memory module 124 that in embodiments can be volatile and/or non-volatile memory, e.g., the memory may be a storage device such as a non-transitory computer-readable storage medium such as a hard drive, compact disk read-only memory (CD-ROM), DVD, or a solid-state memory device. The memory 124 can be physically part of the remote server 122 or can be remote from the remote server 122, e.g., communicatively coupled to the remote server 122 via a wired/wireless connection, via a local area network (LAN), via a wide area network (WAN), via the Network 120, etc.. For ease of discussion the memory 124 is described herein as being part of the remote server 122. Additional details regarding the operation of the remote server are set forth herein.

The computer 132 can be any computing device capable of executing computer modules/code for the functions described herein. For example, the computer can be a personal computer (PC) running on a Windows operating system that is commercially available from Microsoft Corp, Redmond, Wash., a computer running the Mac OS (and variations of) that is commercially available from Apple Computer, Inc., Cupertino, Calif., or other operating systems, a personal device assistant (PDA), a smart phone, e.g., an iPhone, commercially available from Apple Computer Inc. or a phone running the Android operating system, commercially available from Google, Inc, Mountain View, Calif. Other examples include a smart-watch, at tablet computer, e.g., the iPad (commercially available from Apple Computer, Inc) or any other device that can communicate with a network. For ease of discussion, the computer 132 will be described as a personal computer. The computer 132 includes a processor 138, as described above, a communication unit 136 for communicating with the network, a memory module 134, such as the memory modules described herein and an input/output unit 139 that can include input devices, e.g., keyboard, touch screen, mouse and output devices, e.g., a display. The computer 132 and the remote server 122 can be the same device in some embodiments.

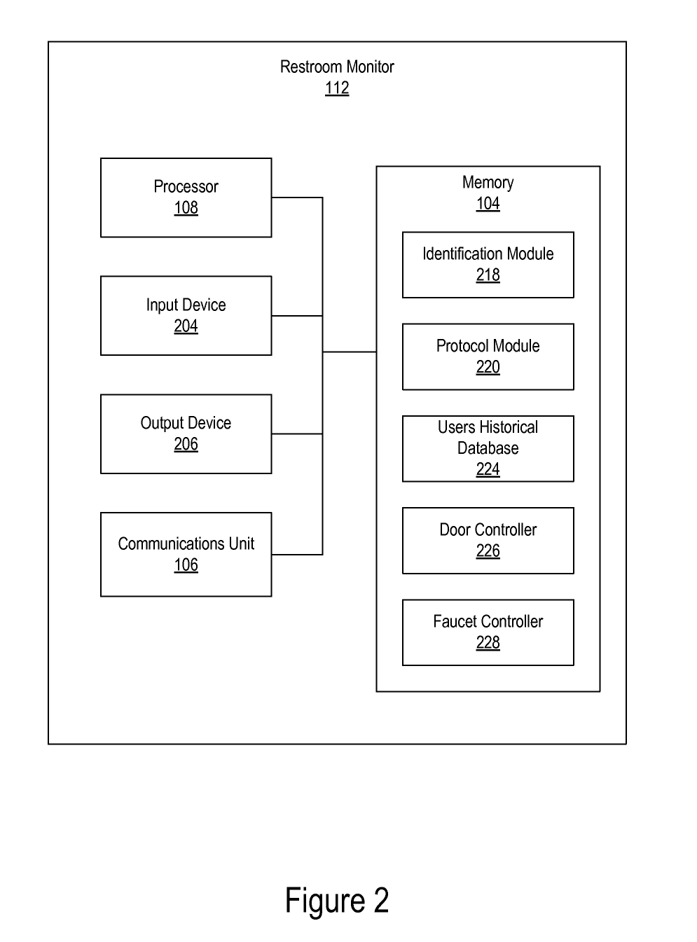

FIG. 2 is a more detailed illustration of a restroom monitor in accordance with an embodiment. The restroom monitor includes a processor 108, an input device 204, an output device 206, a communications unit 106 (transceiver device), and memory 104.

The processor 108 processes data signals and may comprise various computing architectures including a complex instruction set computer (CISC) architecture, a reduced instruction set computer (RISC) architecture, or an architecture implementing a combination of instruction sets. Although only a single processor is shown, multiple processors may be included. The processor 108 comprises an arithmetic logic unit, a microprocessor, a general purpose computer, or some other information appliance equipped to transmit, receive and process electronic data signals from the memory 104, the input device 204, the output device 206, the communications unit 106, and/or the position detection device 210.

The input device 204 is optional and includes any device configured to provide direct user input to the restroom monitor 112 such as, a cursor controller or a keyboard. In one embodiment, the input device 204 can include an alphanumeric input device, such as a QWERTY keyboard, a key pad or representations of such created on a touch screen, adapted to communicate information and/or command selections to processor 108 or memory 104. In another embodiment, the input device 204 is a user input device equipped to communicate positional data as well as command selections to processor 108 such as a joystick, a mouse, a trackball, a stylus, a pen, a touch screen, cursor direction keys or other mechanisms to cause movement adjustment of an image.

The output device 206 is also optional in some embodiments (as are many of the modules depending upon the embodiment) and represents any device equipped to display electronic images and data as described herein. Output device 206 may be, for example, an organic light emitting diode display (OLED), liquid crystal display (LCD), cathode ray tube (CRT) display, or any other similarly equipped display device, screen or monitor. In one embodiment, output device 206 is equipped with a touch screen in which a touch-sensitive, transparent panel covers the screen of output device 206. In one embodiment, the output device 206 is equipped with a speaker that outputs audio.

The communication unit 106 represents a device that allows the restroom monitor 112 to communicate with entities via the network 120 and to components in the system, e.g., faucet controller 228 and door controller 226.

The memory 104 stores instructions and/or data that may be executed by processor 108. The instructions and/or data may comprise code for performing any and/or all of the techniques described herein. Memory 104 may be a dynamic random access memory (DRAM) device, a static random access memory (SRAM) device, Flash RAM (non-volatile storage), combinations of the above, or some other memory device known in the art. The memory 104 includes a plurality of modules adapted to communicate with the processor 108, the input device 204, the output device 206, the communications unit 106, and/or the position detection device 210. The memory modules include an identification module 218 for identifying the user of a restroom, a protocol module 220 for identifying the protocol associated with the identified user, a users historical database 224 that stores information about the users and can be accessed at a later time and or transmitted to remote server 122, the door controller 226 for controlling the operation of the restroom door and the faucet controller 228 for controlling the operation of the faucet, sanitizing device (e.g., soap dispenser) and a hand dryer. Additional details regarding the operation of the restroom monitor 112 are set forth below.

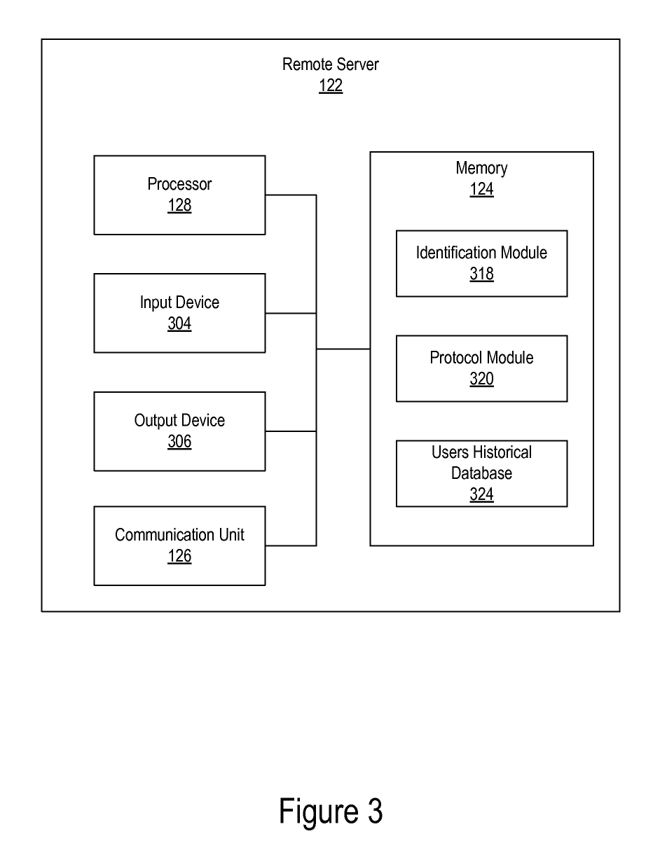

FIG. 3 is a more detailed illustration of a remote server in accordance with an embodiment. The remote server includes a processor 128 that processes data signals and may comprise various computing architectures including a complex instruction set computer (CISC) architecture, a reduced instruction set computer (RISC) architecture, or an architecture implementing a combination of instruction sets. Although only a single processor is shown, multiple processors may be included. The processor 128 comprises an arithmetic logic unit, a microprocessor, a general purpose computer, or some other information appliance equipped to transmit, receive and process electronic data signals from the memory 124, the input device 304, the output device 306, and the communications unit 126, for example.

The input device 304 is any device configured to provide direct user input to the remote server 122 such as, a cursor controller or a keyboard. In one embodiment, the input device 204 can include an alphanumeric input device, such as a QWERTY keyboard, a key pad or representations of such created on a touch screen, adapted to communicate information and/or command selections to processor 128 or memory 124. In another embodiment, the input device 304 is a user input device equipped to communicate positional data as well as command selections to processor 108 such as a joystick, a mouse, a trackball, a stylus, a pen, a touch screen, cursor direction keys or other mechanisms to cause movement adjustment of an image.

The output device 306 represents any device equipped to display electronic images and data as described herein. Output device 306 may be, for example, an organic light emitting diode display (OLED), liquid crystal display (LCD), cathode ray tube (CRT) display, or any other similarly equipped display device, screen or monitor. In one embodiment, output device 306 is equipped with a touch screen in which a touch-sensitive, transparent panel covers the screen of output device 306. In one embodiment, the output device 306 is equipped with a speaker that outputs audio as described herein.

The communication unit 126 represents a device that allows the remote server 122 to communicate with entities via the network 120. The memory 124 stores instructions and/or data that may be executed by processor 128. The instructions and/or data may comprise code for performing any and/or all of the techniques described herein. Memory 124 may be a dynamic random access memory (DRAM) device, a static random access memory (SRAM) device, Flash RAM (non-volatile storage), combinations of the above, or some other memory device known in the art. The memory 124 includes a plurality of modules adapted to communicate with the processor 128, the input device 304, the output device 306, and/or the communications unit 126.

The memory 124 includes an identification module 318 to assist in identifying the user, a protocol monitor to identify the protocol to be used by the identified user and a users historical database to store information about the users protocol procedures. In an embodiment the restroom monitor 112 can identify the user, identify the protocol and maintain a users database, in other embodiments the remote server 122 can perform these function entirely or with assistance from the restroom monitor 112.

As described above, hand sanitation after toilet use is critical to individual and public health, and to the prevention of the spread of disease. For restaurant, food service, and commercial food workers, who are in direct contact with food and beverages, hand sanitation is a mandatory requirement and serious issue impacting public health. This issue also applies to health care workers, and workers in other fields. To a large extent, restaurants, food service, commercial food establishments and other businesses rely solely upon employee training, signage on restroom walls, and written policies and procedures to ensure proper hand sanitation practices are followed. It is currently impractical to monitor or test workers for compliance with hand sanitation polices after each toilet and/or restroom use. Thus, to a large extent, the practice of hand sanitation relies almost entirely on self-discipline and self policing.

The present invention is a system and method for ensuring and monitoring hand sanitization procedures (protocols) in restrooms are followed. The system can include the following elements: (a) a room, (e.g. a restroom), (b) a system and method to identify a person; (c) a system and method to identify a person upon entering a room; (d) a system and method to identify a person upon exiting a room; (e) a sanitary fixture (e.g. a sink and faucet); (f) a cleaning agent dispenser (e.g., soap); (g) a system and method of hand drying (h) a system and method to identify an individual during usage of a sanitary fixture, cleaning agent and drying mechanism; (i) one or more sanitation protocols (e.g., process steps for hand sanitation); (j) a system and method for controlling access to a room, both entering and exiting; (k) a system and method to prevent one or more person(s) from following an authorized or identified person into a room (e.g., prevent tailgating) (l) a system and method for opening and closing a door without a user having to touch a door handle; (m) an alarm or other feedback system and/or indicators; and (n) a restroom monitor 112 and remote server 122, as described above.

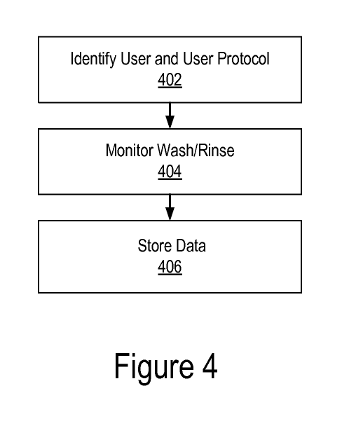

FIG. 4 is a flowchart of the operation of various embodiments. The restroom monitor (RM) 112 identifies 402 the user and the user protocol, then monitors 404 the washing and rinsing of the identified user and stores 406 data regarding the user's following of the protocol.

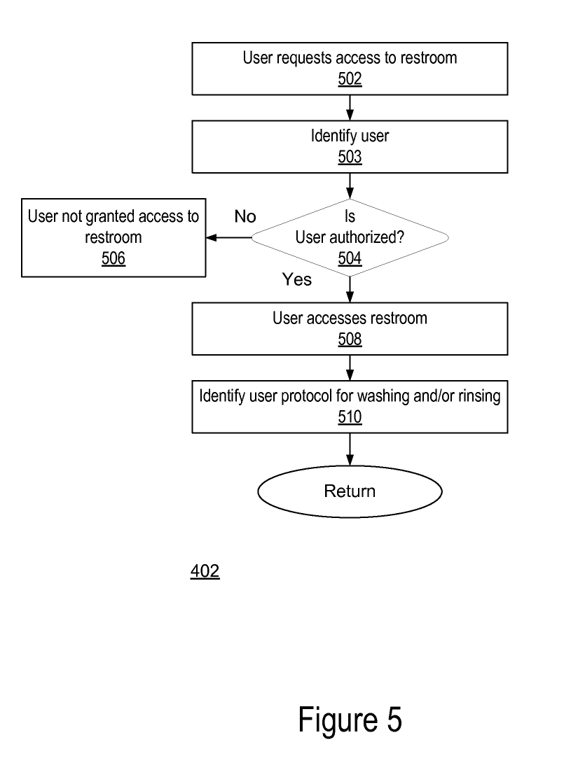

FIG. 5 is a more detailed flowchart of identifying step 402 in accordance with an embodiment.

In one embodiment the system functions as follows: a person whose hand sanitation procedures are of interest enters or requests access 502 to a restroom. An identification system is employed to identify 503 a person automatically, and in some embodiments passively, i.e. without specific input from the person entering the restroom. Embodiments of such recognition technology include the use of a microchip, either an active or a passive radio frequency identification (RFID) tag, either low frequency (LowFID) or high frequency (HighFID). Another embodiment is an optical ID tag. These types of ID tags can be embedded or otherwise affixed to a wearable article. Still another embodiment is a video-optical tracking system employing one or more CCD cameras and infrared light emitting diodes (IRLED). An additional embodiment is video with facial recognition. A further embodiment for unique passive identification is surface acoustic wave technology. Another identification embodiment requires the use of a password or code entered into a conventional lock or other tactile device to enter the restroom which identifies the user or group of users having a similar/same sanitizing protocol. Another embodiment would required a user to present, or swipe an Identification Item (e.g. badge or other) to a reader or scanner.

In one embodiment, the identification module 218 or 318 can make a variety of observations/identifications/actions. As described above, a variety of identification techniques can be used, for ease of discussion the use of an ID tag will be used as an example. The identification module 218 identifies 503 the person attempting to access the restroom and determines 504 whether that person is authorized to enter the restroom which information may be stored and associated with the person. If the person is not authorized the identification module 218 can instruct the door controller 226 to not grant access 506 to the restroom. If the person is authorized then the identification module 218 can instruct the door controller 226 to open and/or unlock the door to grant the user access 508 to the restroom. In an embodiment the protocol module 220 stores specific sanitation protocols for hand washing, rinsing and drying (together referred to as hand washing) and associates these with individual ID tags or groups of identified users. A protocol may consist of washing and rinsing cycles defined by a pre-determined set of steps and faucet outputs such as water temperature, water flow rate, duration of flow and dispensing of soap or cleaning agent and operation and use of hand drying mechanism. In an embodiment, the protocol module identifies 510 the hand washing protocol associated with the identified user.

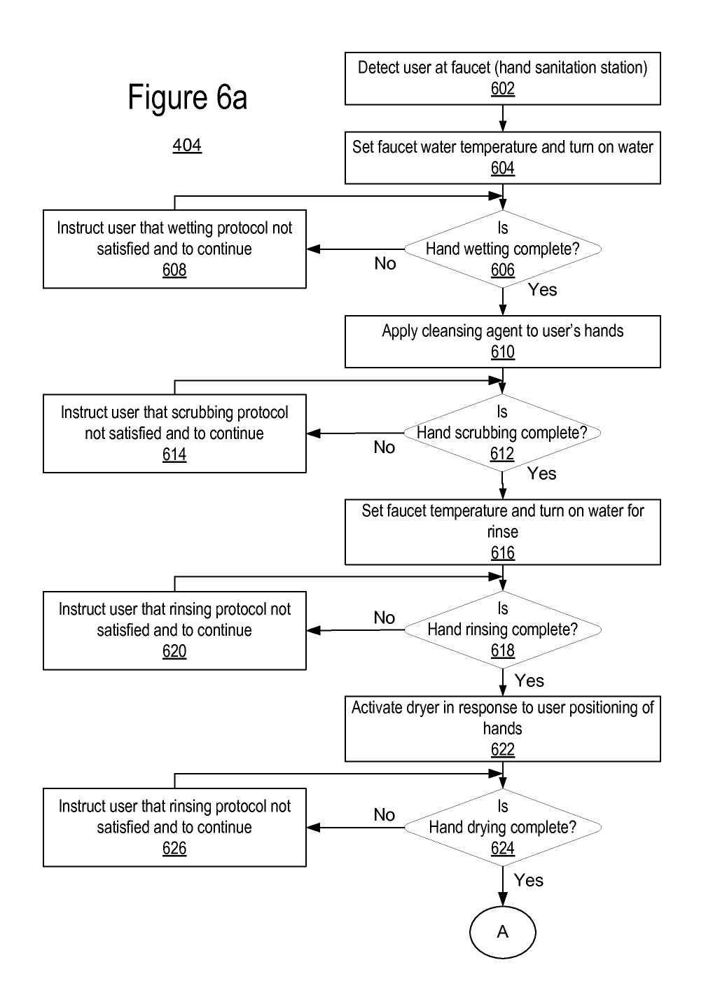

FIGS. 6a-b are a more detailed flowchart of monitoring step 404 in accordance with an embodiment. In an embodiment, the faucet controller 228 can include a possibly separate, identification system with ID tag recognition capability (or other user identification methodology) and may control the hand washing faucet/fixture or station area. The faucet controller determines and records if the person with the ID tag uses the faucet for hand sanitation and whether the proper protocol is followed. When an identified person is detected 602 by the faucet area identification system, the faucet controller 228 initiates a specific sanitation protocol for that user and can automatically run that protocol. For example, the faucet controller 228 can set 604 the faucet water temperature and turn on the water. The faucet controller 228 then determines 606 whether the user sufficiently wet his/her hands. If the user's hands were not sufficiently wet, e.g., based upon the duration that the user's hands should be under the faucet as set forth in the protocol, then the faucet controller 228 can instruct 608 the user that the hand wetting protocol was not satisfied and instruct the user to continue wetting his/her hands. Alternatively, another type of feedback, e.g., pulsating water, a visual cue, an audible alarm, etc., can be activated. In yet another embodiment even if the protocol is not followed, the faucet controller 228 could permit the user to continue. If the faucet controller 228 determines 606 that the hand wetting protocol was satisfied then the faucet controller 228 can apply 610 a cleansing agent to the user's hands, e.g., by sensing the user's hands below a soap dispenser and dispensing soap, by adding a cleansing agent to the flow of water (or other cleaning liquid) out of the faucet.

The faucet controller 228 then determines 612 whether the user sufficiently scrubbed his/her hands. If the user's hands were not sufficiently scrubbed, e.g., based upon the duration that the user's hands should be scrubbed as set forth in the protocol, then the faucet controller 228 can instruct 614 the user that the scrubbing protocol was not satisfied and instruct the user to continue scrubbing. Alternatively, another type of feedback, e.g., pulsating water, a visual cue, an audible alarm, etc., can be activated. In yet another embodiment even if the protocol is not followed, the faucet controller 228 could permit the user to continue. If the faucet controller 228 determines 612 that the hand wetting protocol was satisfied then the faucet controller 228 can set 616 the faucet temperature and turn on the water for the rinsing protocol.

The faucet controller 228 then determines 618 whether the user sufficiently rinsed his/her hands. If the user's hands were not sufficiently rinsed, e.g., based upon the duration that the user's hands should be rinsed as set forth in the protocol, then the faucet controller 228 can instruct 620 the user that the rinsing protocol was not satisfied and instruct the user to continue rinsing. Alternatively, another type of feedback, e.g., pulsating water, a visual cue, an audible alarm, etc., can be activated. In yet another embodiment even if the protocol is not followed, the faucet controller 228 could permit the user to continue. If the faucet controller 228 determines 618 that the rinsing protocol was satisfied then the faucet controller 228 can activate 622 a hand dryer when the user positions his/her hands near the hand dryer for the drying protocol.

The faucet controller 228 then determines 624 whether the user sufficiently dried his/her hands. If the user's hands were not sufficiently dried, e.g., based upon the duration that the user's hands should be dried as set forth in the protocol, then the faucet controller 228 can instruct 626 the user that the drying protocol was not satisfied and instruct the user to continue drying. Alternatively, another type of feedback, e.g., a visual cue, an audible alarm, variable flow air from the hand dryer, etc can be activated. In yet another embodiment even if the protocol is not followed, the faucet controller 228 could permit the user to continue. If the faucet controller 228 determines 624 that the hand drying protocol was satisfied then the protocol module 220 can determine 628 whether the entire protocol has been satisfied.

If 628, the entire protocol has not been satisfied then the protocol module 220 can alert 630 the user of those portions of the protocol that were not satisfied. In an embodiment the user needs to repeat the hand cleaning process. Alternatively, the protocol module 220 may not force the user to repeat the process but will record the result. If 628 the entire protocol has been satisfied then the protocol module can request the door controller 226 to provide access to the exit, e.g., by automatically opening the door or unlocking the door.

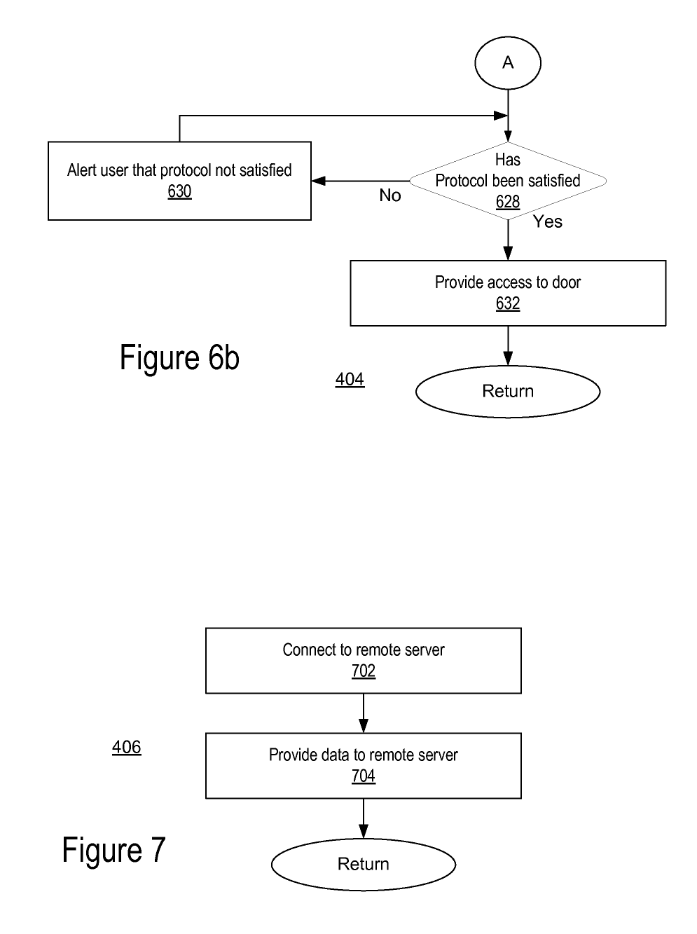

FIG. 7 is a more detailed flowchart of storing step 406 in accordance with an embodiment. The protocol module 220 then optionally connects 702 to the remote server and records that results of the regimen that was run for the specific ID tag or user for that specific occasion when the ID tag was detected in the room. The information is stored 704 in the users historical database 224 and/or 324. In some embodiments the identification system can also detect and record when the individual exits the room. If the system detects a person entering the room, identifies the person and then detects the person exiting the room and if the faucet area recognition system does not detect that specific user and note completion of the required hand sanitation protocol, the system may activate an alarm and signal the remote server 122 that protocol has not been completed, i.e., a person has failed to properly wash his/her hands before exiting the room. As described above, at this point, the system can signal the user that they are out of compliance and indicate that they must immediately return and follow the proper protocol. In an embodiment, this could be done with audible, visual, tactile, or other methods along with email, cell phone, SMS text message or electronic communications to the user and the facilities management. An additional embodiment would include a wearable ID badge with some or all of the following: wireless communications capabilities, a power source and included microcontroller or other type of logic, a prominent visual indicator, and/or audible indicator. In such an embodiment, the hand sanitation control system would communicate with the user's ID badge and change the visual indicator to an ‘alert’ color and/or behavior such as flashing, and/or sound an alarm to indicate to the user, others and/or management that proper hand sanitation protocols were not followed and there is a potentially unsafe condition currently in progress.

For the purposes of this system, the drying mechanism may be a mechanism that only activates when the presence of a users hands are detected by a sensor in the drying mechanism. Use of this drying mechanism allows the system to sense and monitor its use and ensure that is it being used as intended. One example of a drying mechanism would be a forced air system.

In an embodiment, the protocol module 220 synthesizes and stores the data in a retrievable format and/or communicates with one or more electronic devices, such as a network server, a computer or a mobile device, like a PDA, smart phone, etc., through which system data and user interaction can be captured and/or monitored offline, or in real time. Thus, the system can control, track, monitor, record and report the hand sanitation actions of users with respect to the established protocols of any number of uniquely identifiable users each and every time such users enter the restroom.

In an embodiment, video of the tasks performed while the identified user is at the hand sanitation station (e.g., sink area), can be captured during user interactions, and the video can be automatically electronically labeled with a time stamp, and user identification. This secondary data can be used for clarification in cases where hand sanitation station use was atypical, or as a redundancy in case of primary system function failure.

An additional embodiment can include a method for users to alert the system itself and/or its human operators to system trouble. Examples of system trouble can include no water, improper water temperature, lack of supplies, or other anomalies. In an embodiment, a further element of the system is operating software that compiles data from the users historical database 324 and provides means for analytically reporting system use and function for monitoring and auditing purposes.

In one embodiment, the system can be constructed and intended only for users that are required to follow hand sanitation protocols. This can prevent users required to follow hand sanitation protocols from circumventing the system by taking steps to represent themselves to the system as a person that is not subject to hand sanitation protocol requirements. This is because a system that must support users that are required to follow hand sanitation protocols and users that are unknown and unable to be identified allows a loophole for controlled users to be treated as unknown, uncontrolled users.

In an embodiment, the restroom physical design can be implemented in conjunction with the hand sanitation monitoring system and can only include sets of features to be accessed by the user. For example, one door, one toilet, one set of sanitary fixtures (sink, faucet, cleansing agent dispenser, drying mechanism, and accompanying set of sensors, indicators and alarms). This embodiment allows for streamlined user interaction and more straightforward system logic for proper operation.

An additional embodiment can use one room and kiosk segmented areas dividing sets of design elements to be used by one user (e.g., toilet, sink, faucet, cleansing agent dispenser, drying mechanism, and sensors, indicators, alarms)

In a further embodiment, biometrics can be used by the identification modules 218/318 for user identification. Examples include the use of voice recognition, face recognition, fingerprint recognition, feature recognition, retina recognition etc., for user identification. Upon restroom entry, hand sanitation station use and restroom exit, voice recognition (or other biometric recognition information) can be used to identify the user. Entry, sanitation station use and exit may not be granted without proper biometric recognition based approval. This embodiment has the follow advantages. First, users cannot circumvent the system by using someone else's physical identification. Second, it is touchless, no physical item must be handled, or kept on the users person which is more sanitary.

While particular embodiments and applications of the present invention have been illustrated and described herein, it is to be understood that the invention is not limited to the precise construction and components disclosed herein and that various modifications, changes, and variations may be made in the arrangement, operation, and details of the methods and apparatuses of the present invention without departing from the spirit and scope of the invention.

What is claimed is:

1. A computer based method for monitoring sanitation protocols in a restroom comprising the steps of:
automatically identifying a first user of the restroom;
automatically identifying a first sanitation protocol associated with said first user;
automatically monitoring said hand washing activities of said first user in the restroom;
comparing said hand washing activities of said first user with said first protocol to determine whether said first user has followed said first protocol; and
generating an alert signal if said first user does not successfully complete one of a portion of said first protocol and/or all of said first protocol.

2. The method of claim 1, further comprising the step of:
storing a representation of said hand washing activities and a determination of whether said first user followed said first protocol in a digital memory module.

3. The method of claim 2, wherein said digital memory module is located remotely from the restroom.

4. The method of claim 1, wherein said step of automatically monitoring said hand washing activities includes the steps of:
automatically monitoring the hand scrubbing duration of the first user.

5. The method of claim 4, wherein said step of automatically monitoring said hand washing activities includes the steps of:
automatically monitoring the hand wetting duration of the first user.

6. The method of claim 5, wherein said step of automatically monitoring said hand washing activities includes the steps of:
automatically monitoring the hand rinsing duration of the first user.

7. The method of claim 1 wherein the step of automatically identifying the first user includes the steps of:
receiving first user identification information from a tag positioned near said first user; and
comparing said user identification information with a database of approved users to authorizing said first user.

8. The method of claim 1 wherein the step of automatically identifying the first user includes the steps of:
receiving first user biometric information; and
comparing said user biometric information with a database of approved users to authorizing said first user.

9. The method of claim 8, wherein said first user biometric information is received from a biometric sensor, wherein said biometric sensor is one of a audio sensor, visual sensor, and/or tactile sensor.

10. The method of claim 1 wherein the step of automatically identifying the first user includes the steps of:
receiving first user identification information from a tactile device; and
comparing said user identification information with a database of approved users to authorizing said first user.

11. The computer based method of claim 1, wherein said step of automatically identifying said first user includes the steps of: receiving a signal from a tag worn by said first user that identifies said first user.

12. A computer based system for monitoring sanitation protocols in a restroom comprising:
an identification module for receiving identification information and automatically identifying a first user of the restroom;
a protocol module, disposed to receive said identification information, for automatically identifying a first sanitation protocol associated with said first user;
a monitoring module, for automatically monitoring said hand washing activities of said first user in the restroom;
a protocol comparison module for comparing said hand washing activities of said first user with said first protocol to determine whether said first user has followed said first protocol; and
a feedback module, for providing an indicator to the user if said first protocol was not followed.

13. The system of claim 12, further comprising:
a storage device for storing a representation of said hand washing activities and a determination of whether said first user followed said first protocol in a digital memory module.

14. The system of claim 13, wherein said digital memory module is located remotely from the restroom.

15. The system of claim 12, wherein said monitoring module automatically monitors the hand scrubbing duration of the first user.

16. The system of claim 15, wherein said monitoring module automatically monitors the hand wetting duration of the first user.

17. The system of claim 16, wherein said monitoring module automatically monitors the hand rinsing duration of the first user.

18. The system of claim 12 wherein said identification module includes:
an input module for receiving first user identification information from a tag positioned near said first user; and
a comparison module for comparing said user identification information with a database of approved users to authorizing said first user.

19. The system of claim 12 wherein said identification module includes:
an input module for receiving first user biometric information; and
a comparison module for comparing said user biometric information with a database of approved users to authorizing said first user.

20. The system of claim 19, further comprising a biometric sensor for capturing said first user biometric information, said biometric sensor is one of a audio sensor, visual sensor, and/or tactile sensor.

21. The system of claim 12 wherein said identification module includes:
a tactile device for receiving first user identification information; and
a comparison module for comparing said user identification information with a database of approved users to authorizing said first user.

22. The system of claim 12, wherein said identification module automatically receives a signal from a tag worn by said first user that identifies said first user.
